(19) United States
(12) Patent Application Publication
(10) Pub. No.: US 2025/0297868 A1
(43) Pub. Date: Sep. 25, 2025

(54) SYSTEM AND METHOD FOR ENHANCING SECURITY OF ODOMETER INFORMATION

(71) Applicant: TOYOTA JIDOSHA KABUSHIKI KAISHA, Toyota-shi (JP)

(72) Inventor: Caleb MCGARY, Tokyo-to (JP)

(73) Assignee: TOYOTA JIDOSHA KABUSHIKI KAISHA, Toyota-shi (JP)

(21) Appl. No.: 18/612,049

(22) Filed: Mar. 21, 2024

(51) Int. Cl. G01C 22/02; B60W 10/04; B60W 50/04; B60W 50/14

(52) U.S. Cl. CPC G01C 22/02; B60W 10/04; B60W 50/04; B60W 50/14; B60W 2050/146; B60W 2530/18

(57) ABSTRACT

Example embodiments of the present disclosure provide enhancement on security of odometer information of a vehicle. According to embodiments, a method for enhancing security of odometer information is provided. The method may be performed by a system implemented in a vehicle may include: obtaining, from an odometer electronic controller unit (ECU), one or more odometer information; storing the one or more odometer information into an in-vehicle infotainment (IVI) ECU; obtaining a usage table; determining whether or not a boundary condition defined in the usage table is met; and based on determining that the boundary condition is met, storing the one or more odometer information into an e-Fuse based on the usage table.

### TECHNICAL FIELD

Example embodiments of the present disclosure relate to vehicle systems, and more particularly, relate to the enhancement of the security of odometer information in the vehicle systems.

### BACKGROUND

The odometer is a device or system that is utilized in a vehicle to measure and display information associated with the distance traveled by the vehicle. The odometer provides information about the vehicle's usage, maintenance schedule, and potential resale value.

In modern vehicles, the odometer information is usually managed by and stored in a single electronic control unit (ECU), such as an odometer ECU. Such a practice is vulnerable in terms of the security of the odometer information, since a person can easily access the odometer ECU and control the odometer ECU (e.g., replace the ECU, modify the ECU, etc.) to manipulate the odometer information. For instance, the recorded traveled distance can be reset to zero or some other arbitrary number for malicious purposes (e.g., reselling the vehicle at a higher value to an unsuspecting customer, etc.).

In view of the above, the odometer information management in the related art is vulnerable to odometer fraud, and there is a need to enhance the security of the odometer information.

### SUMMARY

Example embodiments consistent with the present disclosure effectively and efficiently provide enhancement on the security of odometer information.

According to example embodiments, a method for enhancing security of odometer information is provided. The method may be performed by a system implemented in a vehicle and may include: obtaining, from an odometer ECU, one or more odometer information; storing the one or more odometer information into an in-vehicle infotainment (IVI) ECU; obtaining a usage table; determining whether or not a boundary condition defined in the usage table is met; and based on determining that the boundary condition is met, storing the one or more odometer information into an e-Fuse based on the usage table.

According to embodiments, a system implemented in a vehicle for enhancing security of the odometer information is provided. The system may include a memory storage configured to store computer-executable instructions and at least one processor communicatively coupled to the memory storage. The at least one processor may be configured to: obtain, from an odometer ECU, one or more odometer information; store the one or more odometer information into an IVI ECU; obtain a usage table; determine whether or not a boundary condition defined in the usage table is met; and based on determining that the boundary condition is met, store the one or more odometer information into an e-Fuse based on the usage table.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a diagram of example components of a vehicle, according to one or more example embodiments;

FIG. 2 illustrates an example usage table, according to one or more example embodiments;

FIG. 3 illustrates block diagrams of example components in a control system, according to one or more example embodiments; and

FIG. 4 illustrates a flow diagram of a method for enhancing security of odometer information, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Related art systems and methods, as described above, manage and store odometer information in a single electronic control unit (ECU), such as the odometer ECU. Example embodiments of the present disclosure, in addition to storing the odometer information in the odometer ECU, also store the odometer information in an additional ECU (e.g., an in-vehicle infotainment (IVI) ECU, a central domain controller (C-DC) ECU, etc.), as well as storing the odometer information into one or more e-Fuses based on a usage table. Accordingly, the risk of the odometer information being compromised and manipulated can be reduced, since the odometer information can be stored in a plurality of vehicle components, particularly in the one or more e-Fuses which are one-time programmable read-only memory (ROM) or write-restricted memory that can be configured to permanently record a newer information and is less accessible from external as compared to the ECUs.

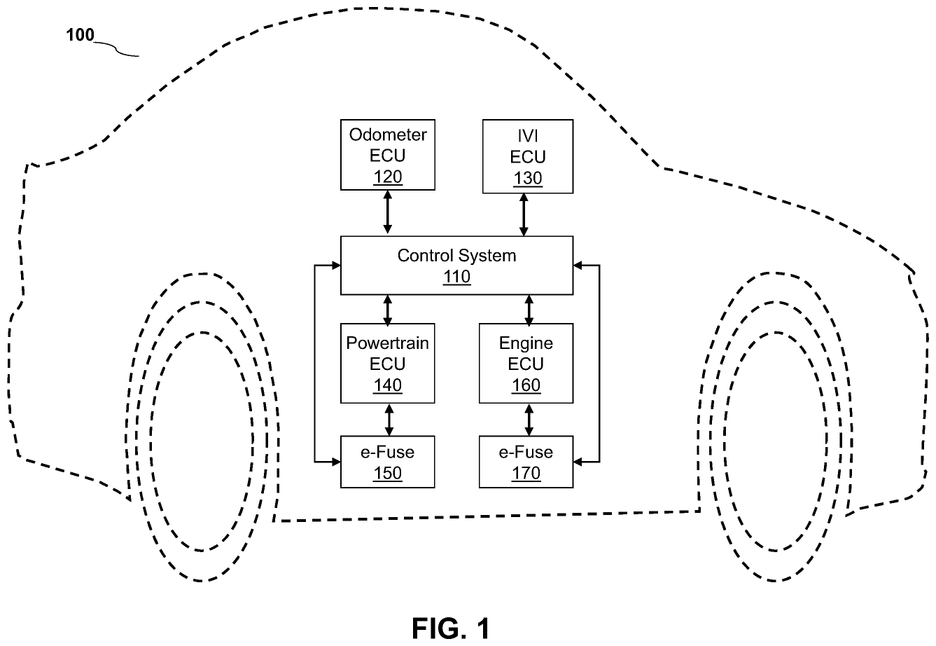

FIG. 1 illustrates a diagram of example components of a vehicle 100, according to one or more example embodiments. As illustrated in FIG. 1, the vehicle 100 may include a control system 110, an odometer ECU 120, an IVI ECU 130, a powertrain ECU 140, an engine ECU 160, an e-Fuse 150 associated with the powertrain ECU 140, and an e-Fuse 170 associated with the engine ECU 160.

It is contemplated that the components of the vehicle 100 are simplified for descriptive purposes, and the vehicle 100 may include additional components and/or may be configured in a different matter in actual implementations, without departing from the scope of the present disclosure. For instance, in some implementations, the vehicle 100 may further include additional ECUs (e.g., C-DC ECU, Advanced Driver Assistance Systems (ADAS) ECU, etc.), an ECU may have multiple e-Fuses associated therewith, and the like.

The control system 110 may be configured to manage one or more odometer information. Specifically, the control system 110 may receive one or more odometer information from the odometer ECU 120, and then appropriately store the odometer information into the IVI ECU 130, as well as into the e-Fuse 160 and e-Fuse 170 (when applicable). The one or more odometer information may include, for example, total mileage or overall distance traveled by the vehicle (e.g., in kilometer (km), miles, etc.), trip mileage (i.e., distance traveled by the vehicle during a specific trip), average traveling speed of the vehicle over a certain period and/or distance, fuel efficiency or fuel consumption of the vehicle over a certain period and/or distance (e.g., in km per liter (km/L), miles per gallon (MPG), etc.), and the like.

According to example embodiments, the control system 110 may periodically store the odometer information into the IVI ECU 130, according to a predefined cycle. For instance, the control system 110 may obtain the odometer information from the odometer ECU 120 and then store the odometer information into the IVI ECU 130 at the beginning of every month. The control system 110 may repeatedly perform such operation for at least a period of time (e.g., for six consecutive months, etc.). Further, the control system 110 may store the odometer information as encrypted and hashed information. Furthermore, the control system 110 may also store the odometer information into another ECU (e.g., C-DC ECU) in addition to or in alternative to the IVI ECU 130, in a similar manner.

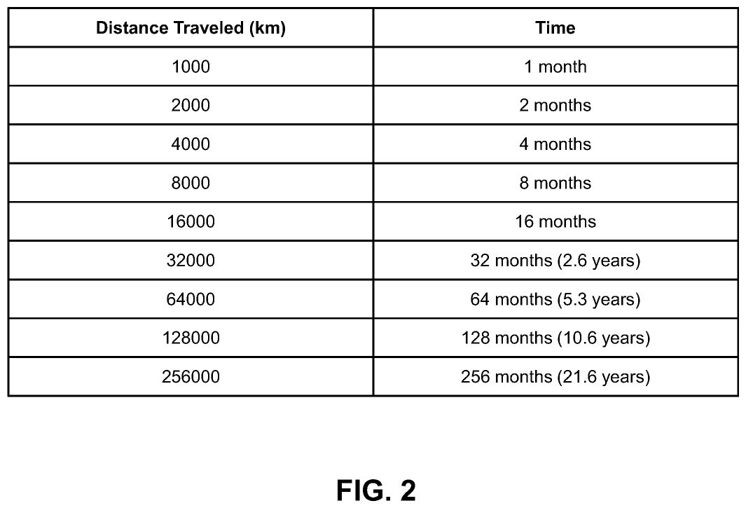

According to example embodiments, the control system 110 may obtain a usage table and then manage the one or more odometer information based on the usage table. Referring to FIG. 2, which illustrates an example usage table, according to one or more example embodiments. As illustrated in FIG. 2, the usage table may include a plurality of mappings of the vehicle traveling distance and the timing for entering or storing the one or more odometer information into one or more e-Fuses. It is contemplated that the usage table in FIG. 2 is merely an example and the scope of the present disclosure should not be limited thereto. Specifically, according to the implementation requirements, the traveled distance may be defined in other suitable units (e.g., miles, etc.), the time may be defined in other suitable units (e.g., days, quarters, etc.), the specific values or parameters in the usage table may be different, and the like.

The usage table defines a boundary condition that initiate the entry or the storing of the odometer information into the one or more e-Fuses. The boundary condition may include a minimum traveling distance, such that whenever the control system 110 determines that the vehicle is entering or has entered a specific state, the control system 110 may determine whether or not a distance traveled by the vehicle has met the minimum traveling distance, and then determine whether or not the odometer information should be entered or stored into the e-Fuse(s). For instance, in the example of FIG. 2, the boundary condition is a minimum traveling distance of 1000 km. In this case, when the control system 110 determines that the vehicle is entering an ignition off (IG-OFF) state (e.g., when the vehicle is shutting down, etc.), the control system 110 may determine whether or not a distance traveled by the vehicle 100 is equal to or longer than 1000 km. Accordingly, based on determining that the distance traveled by the vehicle 100 is equal to or longer than 1000 km, the control system 110 may determine that the boundary condition for storing the odometer information into the one or more e-Fuses is met, thereby initiating the entry or storing of the odometer information.

When an entry or storing of the odometer information into the e-Fuse(s) is required, the control system 110 may obtain the usage table and select, based on the distance traveled by the vehicle, a mapping from among the plurality of mappings included in the usage table. Accordingly, the control system 110 may determine, based on the select mapping, a timing to store the odometer information into the e-Fuse(s), and then store the odometer information into the e-Fuse(s) according thereto. By way of example, based on determining that the vehicle 110 has traveled 2500 km, the control system 110 may determine that the odometer information should be stored into the e-Fuse(s) every 2 months. Accordingly, the control system 110 may store the odometer information into the e-Fuse(s) every 2 months, in addition to storing the odometer information into the IVI ECU (or the C-DC ECU). The control system 110 may store the odometer information as encrypted and hashed information.

According to example embodiments, the usage table may be an exponential growth-based usage table. In this case, the plurality of mappings in the usage table may be based on an exponential growth algorithm of, for example, y=a(1+r)^{t}, in which the y represents a future value, a represents an initial or starting value, r represents a growth rate, and t represents the time elapsed since the beginning of the growth process. In other words, many entries or storing of the odometer information into the e-Fuse(s) happen earlier in a vehicle lifespan and less as the vehicle commutes more distance, as the distance traveled between use of e-Fuses grows larger. Accordingly, a vehicle that travels longer distances rapidly will have more frequent writes to the e-Fuses initially but less over time in order to maintain the exponential growth rate. This allows for optimal use of the e-Fuses in storing the odometer information, particularly when the number of e-Fuses is limited in the vehicle.

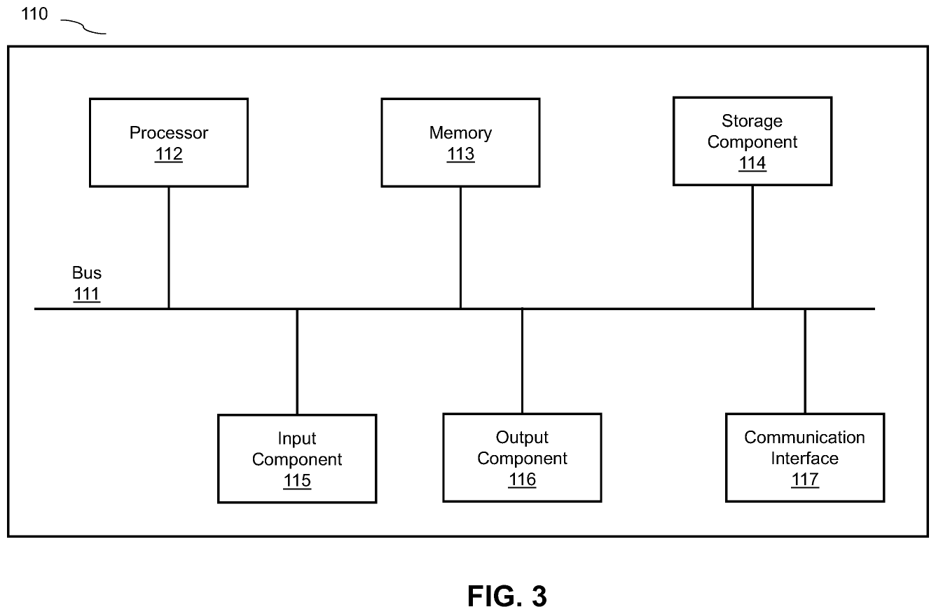

According to example embodiments, the usage table may be stored in the odometer ECU and be obtained by the control system 110 when required. Additionally or alternatively, the usage table may be stored in a storage medium of the control system 110 (examples of the storage medium are further described below with reference to FIG. 3). By default, the usage table may be an exponential growth-based table as described hereinabove. When required, the control system 110 may update the usage table to reflect the current usage trend. For instance, the control system 110 may determine whether or not the usage of the vehicle has exceeded a predefined period (e.g., six months), and then perform a slope line analysis to determine a current usage trend of the vehicle, based on determining that the usage of the vehicle has exceeded the predefined period (e.g., after six months). Accordingly, the control system 110 may update the usage table to reflect the current usage trends.

According to example embodiments, the control system 110 may initiate one or more vehicle operations according to a state of the vehicle. Specifically, based on determining that the vehicle is entering or has entered an ignition ON (IG-ON) state (e.g., when the vehicle first boots up, etc.), prior to entering to the driving state, the control system 110 may check the odometer information stored in the IVI ECU (and/or another ECU like the C-DC ECU) via, for example, a cryptographic challenge or a secure boot validation. Similar verification may also be initiated by other vehicle components like, for example, the ADAS ECU.

According to example embodiments, based on determining that the vehicle is entering or has entered the IG-ON state, the control system 110 may compare the odometer information stored in the IVI ECU (and/or another ECU like the C-DC ECU) with the odometer information stored in the e-Fuse(s). For instance, the control system 110 may obtain the odometer information from the IVI ECU and the e-Fuse(s), and then compare (e.g., via hashing) the obtained odometer information thereafter. Based on determining that the odometer information stored in the IVI ECU is different from the odometer information stored in the e-Fuse(s), the control system 110 may initiate one or more vehicle operations, such as displaying a message to notify a driver of the vehicle (e.g., sending an error code on a display, activating the vehicle's check engine light, etc.), instructing an engine immobilizer to disable one or more operations of the engine of the vehicle (e.g., disabling the ignition of the engine, etc.), and the like.

According to example embodiments, the control system 110 (or one or more operations associated therewith) may be implemented in one or more ECUs. For instance, the control system 110 (or one or more operations associated therewith) may be implemented in the odometer ECU 120, the IVI ECU 130, the powertrain ECU 140, the engine ECU 150, and/or any other suitable ECUs like the C-DC ECU and ADAS ECU.

Referring still to FIG. 1, the odometer ECU 120 may be configured to measure, track, and record one or more odometer information associated with the vehicle 100. For instance, the odometer ECU 120 may receive inputs from sensors (e.g., sensors for monitoring the movement of the vehicle, etc.) and then process the sensors' inputs to calculate the distance traveled by the vehicle. Upon determining the odometer information, the odometer ECU 120 may store the odometer information in its own memory storage, as well as provide the odometer information to the control system 110 for further processing.

The IVI ECU 130 may be configured to manage the vehicle's information and entertainment system, including audio playback, video display, and navigation. In addition, the IVI ECU 130 may also provide interfaces to external devices like smartphones or navigation devices, as well as provide user interfaces for accessing and controlling various infotainment functions. Further, the IVI ECU 130 may also receive the odometer information (from the control system 110) and then store the odometer information in its memory storage. In this regard, the IVI ECU 130 may act as an additional ECU for storing the odometer information, thereby providing redundancy or backup of the odometer information. Further, the IVI ECU 130 may also be configured to present the odometer information to the driver via one or more displays in the vehicle 100 (e.g., IVI display, navigation display, etc.).

The powertrain ECU 140 may be configured to control operations of the vehicle's powertrain, which typically involves the transmission components and drivetrain. For instance, the powertrain ECU 140 may be configured to manage transmission shifting and torque distribution in the vehicle 100. The e-Fuse 150 may include one or more non-volatile memories (e.g., ROM, write-restricted memory, etc.) that can be configured to interoperate with the powertrain ECU 140 and store the associated information (e.g., version information of the powertrain ECU 140, etc.). In some implementations, the e-Fuse 150 may further include a microscopic fuse that is implemented into a component (e.g., computer chip, etc.) on which the powertrain ECU 140 is deployed. The e-Fuse 150 may receive odometer information from the control system 110 and then store the odometer information therein. According to example embodiments, the control system 110 may first transmit the odometer information to the powertrain ECU 140, and the powertrain ECU 140 may then transmit the odometer information to the e-Fuse 150.

The engine ECU 160 may be configured to monitor and control the operation of the engine of the vehicle 100. For instance, the engine ECU 160 may monitor the engine and adjust fuel injection, enable or disable ignition of the engine, manage idle speed control and engine shutdown/startup procedures, and the like. According to example embodiments, the engine ECU 160 may be configured to provide, to the control system 110, information of the ignition state of the vehicle (e.g., IG-ON, IG-OFF, etc.). Similar to the e-Fuse 150, the e-Fuse 170 may include one or more non-volatile memories (e.g., ROM, write-restricted memory, etc.) that can be configured to interoperate with the engine ECU 160 and store the associated information (e.g., version information of the engine ECU 160, etc.). In some implementations, the e-Fuse 170 may further include a microscopic fuse that is implemented into a component (e.g., computer chip, etc.) on which the engine ECU 160 is deployed. The e-Fuse 170 may receive odometer information from the control system 110 and then store the odometer information therein. According to embodiments, the control system 110 may first transmit the odometer information to the engine ECU 160, and the engine ECU 160 may then transmit the odometer information to the e-Fuse 170.

Referring next to FIG. 3, which illustrates block diagrams of example components in the control system 110, according to one or more example embodiments. As illustrated in FIG. 3, the control system 110 may include at least one bus 111, at least one processor 112, at least one memory 113, at least one storage component 114, at least one input component 115, at least one output component 116, and at least one communication interface 117.

It is contemplated that the control system 110 may include more or less components than illustrated in FIG. 3, and/or the components associated therewith may be arranged in a different manner than illustrated in FIG. 3, without departing from the scope of the present disclosure. For instance, in some embodiments, the control system 110 may include a plurality of storage components 114, the input component 115 and the output component 116 may be implemented as a transceiver component, the memory 113 and storage component 114 may be implemented as a memory storage, and the like.

The bus 111 may be configured to facilitate or enable communications among the components of the control system 110. Specifically, the bus 111 may communicatively couple the components to each other and provide a means for data transfer and flow of control signals between the components. The bus 111 may include one or more of: an internal bus, an address bus, a data bus, a control bus, a controller area network (CAN) bus, an Ethernet bus, a peripheral component interconnect express (PCIe) bus, and any other suitable type of bus that can be implemented in the control system 110 to enable communication and coordination between the components within the control system 110 in real-time (or near real-time).

The processor 112 may be implemented in hardware, firmware, or a combination of hardware and software, and may be configured to handle real-time (or near real-time) data processing and control of the control system 110. The processor 112 may include one or more of: a central processing unit (CPU), a graphics processing unit (GPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the control system 110. In some implementations, the processor 112 may be capable of being programmed to perform one or more operations described herein. Further, the processor 112 may include a plurality of processing units, each of which is dedicated to perform a specific operation (e.g., one processing unit may be assigned to handle communication with the ECUs, one processing unit may be assigned to handle communication with the e-Fuses, etc.).

The memory 113 may include one or more mediums for storing temporary data, runtime variables, program instructions, and buffers required for the operations of the control system 110. The memory 113 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the control system 110 to store information and/or instructions for use by the processor 112.

The storage component 114 may be configured to store non-volatile data, such as firmware, configuration settings, calibration data, information, and/or software related to the operation and use of the control system 110. For example, the storage component 114 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 114 may be configured to store computer-readable or computer-executable instructions for implementing one or more operations of the control system 110, one or more usage tables, information of one or more predefined timings for storing the odometer information into the IVI ECU (or any other suitable ECU), information for implementing one or more exponential growth algorithms, information for implementing one or more sloped line analysis, information for implementing one or more vehicle operations, and the like. The storage component 114 may provide the stored information to the memory 113 for the execution of the processor 112.

The input component 115 may include one or more input components that permit the control system 110 to receive information, such as via user input (e.g., a touch screen display, a keyboard, a keypad, a mouse, a button, a switch, and/or a microphone). The output component 116 may include one or more output components that provide output information from the system 110 (e.g., a display, a speaker, a navigation device, one or more light-emitting diodes (LEDs), etc.). According to embodiments, the input component 115 and/or the output component 116 may be optional and may be excluded from the control system 110.

The at least one communication interface 117 may include a transceiver-like component (e.g., a transceiver and/or a separate receiver and transmitter) that enables the control system 110 to communicate with other vehicle components (e.g., ECUs, e-Fuses, etc.), such as via a wired connection, a wireless connection, or a combination of wired and wireless connections. For example, communication interface 117 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 117 may include at least one input/output (I/O) interface, at least one network interface, at least one storage interface, or the like, that enable the components 112-116 to communicate with other vehicle components. Further, the communication interface 117 may include one or more application programming interfaces (APIs) that allow the control system 110 (or one or more components included therein) to communicate with one or more software applications (e.g., software application deployed in the ECUs, etc.).

Computer-executable instructions (e.g., software instructions, etc.) may be read into memory 113 and/or storage component 114 from another computer-readable medium or from another device (e.g., a remote server, an external storage, etc.) via the communication interface 117. When executed, the computer-executable instructions stored in memory 113 and/or storage component 114 may cause the processor 112 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

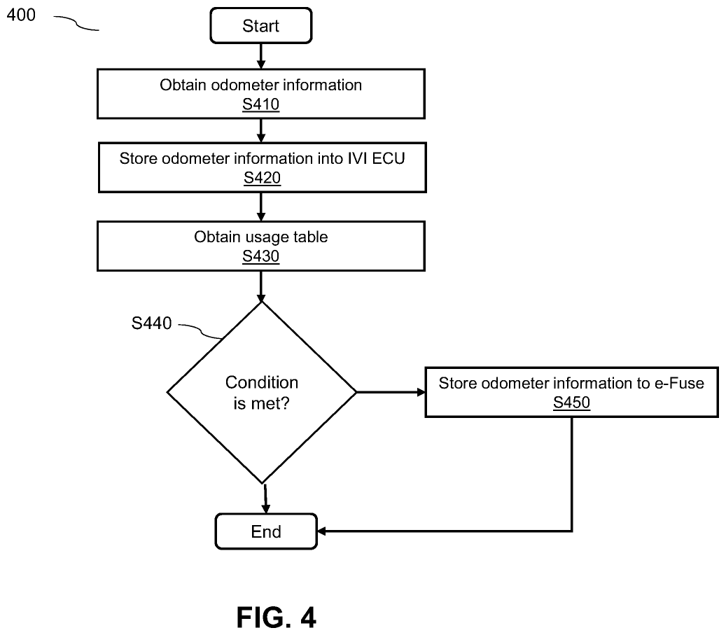

FIG. 4 illustrates a flow diagram of a method 400 for enhancing security of odometer information, according to one or more example embodiments. The method may be performed by at least one processor (e.g., processor 112) of a system in a vehicle (e.g., control system 110), upon executing computer-readable instructions stored in one or more memory storages (e.g., memory 113, storage component 114, etc.). The method 400 may be triggered regularly or periodically.

As illustrated in FIG. 4, at operation S410, the at least one processor may be configured to obtain, from an odometer ECU (e.g., ECU 120), one or more odometer information. The one or more odometer information may include, for example, total mileage or overall distance traveled by the vehicle (e.g., in km, miles, etc.), trip mileage (i.e., distance traveled by the vehicle during a specific trip), average traveling speed of the vehicle over a certain period and/or distance, fuel efficiency or fuel consumption of the vehicle over a certain period and/or distance (e.g., in km per liter (km/L), miles per gallon (MPG), etc.), and the like.

At operation S420, the at least one processor may be configured to store the one or more odometer information to an IVI ECU (or any other suitable ECU like the C-DC ECU). According to example embodiments, the at least one processor may periodically store the one or more odometer information into the IVI ECU according to a predefined cycle (e.g., at the beginning of every month, etc.)

At operation S430, the at least one processor may be configured to obtain a usage table. For instance, the usage table may be stored in a storage of the control system (e.g., memory 113, storage component 114, etc.) and the at least one processor may obtain the usage table from the storage. As another example, the usage table may be stored or implemented in the odometer ECU. In this case, the at least one processor may communicate with the odometer ECU to obtain the usage table. The usage table may include an exponential growth-based usage table including a plurality of mappings based on an exponential growth rate, and each of the mappings may include a distance traveled by the vehicle and an associated timing to store the one or more odometer information into one or more e-Fuses. An example of the usage table have been described above with reference to FIG. 2.

At operation S440, the at least one processor may be configured to determine whether or not a boundary condition defined in the usage table is met. For instance, the usage table may include a minimum traveling distance. In this case, the at least one processor may determine whether or not the boundary condition is met by: determining whether or not the vehicle is entering or has entered an ignition off (IG-OFF) state; based on determining that the vehicle is entering or has entered the IG-OFF state, determining whether or not a distance traveled by the vehicle has met the minimum traveling distance; based on determining that the distance traveled by the vehicle is equal to or longer than the minimum traveling distance, determining that the boundary condition is met; and based on determining that the distance traveled by the vehicle is shorter than the minimum traveling distance, determining that the boundary condition is not met.

Based on determining that the boundary condition is not met, the method 400 may be ended or terminated, and the one or more odometer information will not be stored or entered to any e-Fuse. Conversely, based on determining that the boundary condition is met, the at least one processor may be configured to store the one or more odometer information into one or more e-Fuses based on the usage table. For instance, the at least one processor may store the one or more odometer information by: selecting, based on the distance traveled by the vehicle, a mapping from among the plurality of mappings; determining, based on the selected mapping, a timing to store the one or more odometer information into the one or more e-Fuses; and storing the one or more odometer information into the one or more e-Fuses according to the determined timing. According to example embodiments, a portion of the odometer information may be stored in a first e-Fuse, and another portion of the odometer information may be stored in a second e-Fuse. The one or more e-Fuses may include an e-Fuse associated with a powertrain ECU and/or an e-Fuse associated with an engine ECU.

It is contemplated that the flow diagram in FIG. 4 illustrates only a possible embodiment, and the scope of the present disclosure should not be limited thereto. Specifically, in some implementations, the method 400 may include more/less operation than illustrated in FIG. 4.

For example, according to example embodiments, the method 400 may further include operations for updating the usage table. In this case, the at least one processor may be configured to update the usage table by: determining whether or not the usage of the vehicle has exceeded a predefined period; based on determining that the usage of the vehicle has exceeded the predefined period, performing a slope line analysis to determine a current usage trend of the vehicle; and updating the usage table based on the current usage trend.

Additionally, the method 400 may further include operations for initiating one or more vehicle operations, such as displaying a message to notify a driver of the vehicle, instructing an engine immobilizer to disable one or more operations of the engine of the vehicle, and the like. In this case, the at least one processor may be configured to initiate the one or more vehicle operations by: determining whether or not the vehicle is entering or has entered an ignition ON (IG-ON) state; based on determining that the vehicle is entering or has entered the IG-ON state, comparing the one or more odometer information stored in the IVI ECU with the one or more odometer information stored in the e-Fuse; based on determining that the one or more odometer information stored in the IVI ECU is different from the one or more odometer information stored in the e-Fuse, initiating one or more vehicle operations.

Further descriptions of the specific operations associated with operations of the method 400 have been provided above with reference to FIG. 1 and FIG. 2. Thus, redundant descriptions associated therewith may be omitted below for conciseness.

To this end, example embodiments of the present disclosure provide enhanced security on the odometer information. Specifically, as compared to storing and managing the odometer information in a single odometer ECU in the related art, example embodiments of the present disclosure store the odometer information to at least one additional ECU (e.g., IVI ECU, C-DC ECU, etc.) and one or more e-Fuses. The entry or storing of the odometer information to the e-Fuse(s) is initiated and performed according to the usage table (which is regularly updated according to the latest usage trend of the vehicle). In this way, the timing to make an entry or store the odometer information into the e-Fuse(s) is decided according to the driver behavior, optimizing the utilization of e-Fuses in the vehicle. Further, the odometer information stored in different vehicle components (e.g., ECUs, e-Fuses, etc.) may be utilized to verify the accuracy and integrity of the odometer information and one or more operations (e.g., engine immobilization, etc.) may be performed based thereon, effectively reducing the risk of odometer fraud.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, performed by at least one processor of a system implemented in a vehicle to enhance security of odometer information, comprising:
obtaining, from an odometer electronic controller unit (ECU), one or more odometer information;
storing the one or more odometer information into an in-vehicle infotainment (IVI) ECU;
obtaining a usage table;
determining whether or not a boundary condition defined in the usage table is met; and
based on determining that the boundary condition is met, storing the one or more odometer information into an e-Fuse based on the usage table.

2. The method according to claim 1, wherein the storing the one or more odometer information into the IVI ECU comprises:
periodically storing the one or more odometer information into the IVI ECU according to a predefined cycle.

3. The method according to claim 1, wherein the boundary condition comprises a minimum traveling distance, and wherein the determining whether or not the boundary condition is met comprises:
determining whether or not the vehicle has entered an ignition off (IG-OFF) state;
based on determining that the vehicle has entered the IG-OFF state, determining whether or not a distance traveled by the vehicle has met the minimum traveling distance;
based on determining that the distance traveled by the vehicle is equal to or longer than the minimum traveling distance, determining that the boundary condition is met; and
based on determining that the distance traveled by the vehicle is shorter than the minimum traveling distance, determining that the boundary condition is not met.

4. The method according to claim 1, wherein the usage table is an exponential growth-based usage table comprising a plurality of mappings based on an exponential growth rate, and wherein each of the mappings comprises a distance traveled by the vehicle and an associated timing to store the one or more odometer information into the e-Fuse.

5. The method according to claim 4, wherein the storing the one or more odometer information into the e-Fuse comprises:
selecting, based on the distance traveled by the vehicle, a mapping from among the plurality of mappings;
determining, based on the selected providing mapping, a timing to store the one or more odometer information into the e-Fuse; and
storing the one or more odometer information into the e-Fuse according to the determined timing.

6. The method according to claim 1, further comprising:
determining whether or not the usage of the vehicle has exceeded a predefined period;
based on determining that the usage of the vehicle has exceeded the predefined period, performing a slope line analysis to determine a current usage trend of the vehicle; and
updating the usage table based on the current usage trend.

7. The method according to claim 1, further comprising:
determining whether or not the vehicle has entered an ignition ON (IG-ON) state;
based on determining that the vehicle has entered the IG-ON state, comparing the one or more odometer information stored in the IVI ECU with the one or more odometer information stored in the e-Fuse; and
based on determining that the one or more odometer information stored in the IVI ECU is different from the one or more odometer information stored in the e-Fuse, initiating one or more vehicle operations.

8. The method according to claim 7, wherein the one or more vehicle operations comprise:
displaying a message to notify a driver of the vehicle.

9. The method according to claim 7, wherein the one or more vehicle operations comprise:
instructing an engine immobilizer to disable one or more operations of the engine of the vehicle.

10. The method according to claim 1, wherein the e-fuse comprises one or more of: an e-Fuse associated with a powertrain ECU and an e-Fuse associated with an engine ECU.

11. A system implemented in a vehicle for enhancing security of odometer information, the system comprising:
a memory storage storing computer-executable instructions; and
at least one processor communicatively coupled to the memory storage, wherein the at least one processor is configured to execute the instructions to:
obtain, from an odometer electronic controller unit (ECU), one or more odometer information;
store the one or more odometer information into an in-vehicle infotainment (IVI) ECU;
obtain a usage table;
determine whether or not a boundary condition defined in the usage table is met; and
based on determining that the boundary condition is met, store the one or more odometer information into an e-Fuse based on the usage table.

12. The system according to claim 11, wherein the at least one processor is configured to store the one or more odometer information into the IVI ECU by:
periodically storing the one or more odometer information into the IVI ECU according to a predefined cycle.

13. The system according to claim 11, wherein the boundary condition comprises a minimum traveling distance, and wherein the at least one processor is configured to determine whether or not the boundary condition is met by:
determining whether or not the vehicle is entering an ignition off (IG-OFF) state;
based on determining that the vehicle is entering the IG-OFF state, determining whether or not a distance traveled by the vehicle has met the minimum traveling distance;
based on determining that the distance traveled by the vehicle is equal to or longer than the minimum traveling distance, determining that the boundary condition is met; and
based on determining that the distance traveled by the vehicle is shorter than the minimum traveling distance, determining that the boundary condition is not met.

14. The system according to claim 11, wherein the usage table is an exponential growth-based usage table comprising a plurality of mappings based on an exponential growth rate, and wherein each of the mappings comprises a distance traveled by the vehicle and an associated timing to store the one or more odometer information into the e-Fuse.

15. The system according to claim 14, wherein the at least one processor is configured to store the one or more odometer information into the e-Fuse by:
selecting, based on the distance traveled by the vehicle, a mapping from among the plurality of mappings;
determining, based on the selected mapping, a timing to store the one or more odometer information into the e-Fuse; and
storing the one or more odometer information into the e-Fuse according to the determined timing.

16. The system according to claim 11, wherein the at least one processor is further configured to:
determine whether or not the usage of the vehicle has exceeded a predefined period;
based on determining that the usage of the vehicle has exceeded the predefined period, perform a slope line analysis to determine a current usage trend of the vehicle; and
updating the usage table based on the current usage trend.

17. The system according to claim 11, wherein the at least one processor is further configured to:
determine whether or not the vehicle is entering an ignition ON (IG-ON) state;
based on determining that the vehicle is entering the IG-ON state, compare the one or more odometer information stored in the IVI ECU with the one or more odometer information stored in the e-Fuse;
based on determining that the one or more odometer information stored in the IVI ECU is different from the one or more odometer information stored in the e-Fuse, initiate one or more vehicle operations.

18. The system according to claim 17, wherein the one or more vehicle operations comprise:
displaying a message to notify a driver of the vehicle.

19. The system according to claim 17, wherein the one or more vehicle operations comprise:
instructing an engine immobilizer to disable one or more operations of the engine of the vehicle.

20. The system according to claim 11, wherein the e-fuse comprises one or more of: an e-Fuse associated with a powertrain ECU and an e-Fuse associated with an engine ECU.
